(19) United States
(12) Patent Application Publication
(10) Pub. No.: US 2005/0115273 A1
(43) Pub. Date: Jun. 2, 2005

(54) Multistage fluid separation assembly and method

(76) Inventors: Hillegonda Bakker, Rijswijk (NL); Max Robert Anthony Ter Haar, Rijswijk (NL); Fred Toshio Okimoto, Rijswijk (NL); Cornelis Antonie Tjeenk Willink, Rijswijk (NL)

Correspondence Address: Richard F. Lemuth;Shell Oil Company, Intellectual Property, P O Box 2463, Houston, TX, 77252-2463, US

(21) Appl. No.: 10/500,280

(22) PCT Filed: Dec. 31, 2002
(86) PCT No.: PCT/EP02/14864

(30) Foreign Application Priority Data
Dec. 31, 2001 (EP) 01205147.0

(51) Int. Cl. C02F 1/22; B01D 9/04; F25J 1/00; B01D 19/00

(52) U.S. Cl. 62/601; 62/532; 62/537; 96/184

(57) ABSTRACT

A multistage fluid separation assembly is disclosed, which includes one or more primary gas cooling devices which each have liquefied and/or solidified condensables enriched fluid outlet, and, a secondary fluid separation vessel having a tubular vertical section. The vessel is connected to the condensables enriched fluid outlet of the primary gas cooling device(s) via a tangential conduit which injects the condensables enriched fluid tangentially into the tubular section such that a tertiary stream of liquified and/or solidified condensables is induced by gravity and centrifugal forces to swirl in downward direction alongside the inner surface of the tubular section into a liquid collecting tank at or near the bottom of the vessel for collecting a tertiary mixture of liquified and/or solidified condensables. The tank is provided with one or more heaters for heating the tertiary mixture to reduce the amount of solidified condensables, such as wax, paraffins and hydrates, and with one or more liquid outlets.

### BACKGROUND OF THE INVENTION

The invention relates to a multistage fluid separation assembly and method.

In many oil and/or gas production wells the well effluents may comprise complex fluid mixtures which contain crude oil, natural gas (methane), water, brine, condensates, sulphur, hydrogen sulphide and other components.

During production the well effluents expand and generally cool down from reservoir temperatures which may be between 100 and 200 degrees Celsius to significantly lower atmospheric or submarine temperatures.

This causes condensation and/or solidification of various components and formation of hydrate, wax and/or asphaltene deposits in the production tubulars and equipment.

It is known from U.S. Pat. No. 4,026,120 to remove condensable and/or solidifiable components from the produced well effluents at the wellhead by cooling down the well effluents in a choke and injecting the cooled well effluents into a so called ‘LTX’ (Low Temperature expansion) vessel in which the liquified and/or solidified components, such as water, wax, asphaltenes and hydrates drip down to the bottom, where they are heated to about 20 degrees Celsius to create a pumpable liquid slurry which is then pumped into a liquid discharge conduit at the bottom part of the LTX vessel. The gaseous components are removed from the LTX vessel via a gas outlet conduit near the upper end of the LTX vessel.

U.S. Pat. No. 4,208,196 discloses an LTX vessel into which well effluents are injected without prior expansion in a choke. The known LTX vessel is provided with a vertically oriented tubular inlet section into which the well effluents are injected tangentially to enhance segregation of liquefied and/or solidified components from the gaseous components by centrifugal forces. The tubular inlet section is capped and provided with a grating structure at its lower end to inhibit extension of the swirl induced in the inlet section into the liquid collecting region at the bottom of the LTX tank. The tubular inlet section is located inside a cylindrical and horizontal separation tank in which water and oil are collected and separated from each other by gravity segregation, and are subsequently tapped off via separate water and oil discharge tubes near the bottom of the tank. The gaseous components are induced to flow through the grating down from the tubular inlet section into the separation tank and removed from the top of the separation tank at a significant distance from the inlet section.

International patent application PCT/NL00/00382 discloses a separation vessel for separating heavy, such as liquid or solid, components from a gaseous mixture in which vessel countercurrent inner and outer swirls are induced by countercurrent swirl imparting vanes arranged near the center and outer periphery of the vessel. A disadvantage of this known device is that the swirl imparting vanes are prone to fouling.

International patent application PCT/EP98/04178 discloses a supersonic cyclonic inertia separator in which the produced well effluents are drastically cooled down by adiabatic expansion as a result of their acceleration to a supersonic velocity in a supersonic nozzle. In the supersonic nozzle a swirl is created to segregate the thus condensed and/or solidified heavy components from the lighter gaseous components. The gaseous condensables depleted components are discharged from the separator through a central primary gas outlet conduit whereas the condensables enriched components are discharged from the separator through one or more secondary outlet conduits which extend away from a central axis of the nozzle.

It has been found that the secondary condensables enriched fluid outlet of a supersonic cyclonic inertia separator may be connected to an LTX vessel, but that the high velocity of the injected liquefied and/or solidified condensables enriched fluid mixture resulted in a reduced gravity separation efficiency of the LTX vessel. The multistage fluid separation assembly and method according to the preamble of claims 1 and 17 are known from U.S. Pat. No. 2,825,423. In the known assembly fluid is injected into a tubular section of a secondary separation vessel via a single secondary fluid injection conduit, which may lead to instability of the vortex in, and separating performance of, the secondary separation vessel if the pressure and velocity of the injected fluid fluctuates.

It is an object of the present invention to provide a hybrid multistage fluid separation assembly in which an LTX type separation vessel is connected to liquefied and/or solidified condensables enriched fluid outlet of one or more gas cooling devices such as supersonic and/or subsonic cyclonic inertia separators such that a synergetic effect is obtained between the performance of the gas cooling device, such as a cyclonic inertia separator, and the LTX separation vessel.

It is a further object to provide a hybrid multistage fluid separation assembly, which is more compact than a combination of a gas cooling device, such as a cyclonic inertia separator, and a conventional LTX vessel.

It is yet a further object to provide a hybrid multistage fluid separation assembly in which a plurality of gas cooling devices, such as cyclonic inertia separators, can be connected to a single compact LTX vessel by relatively short liquefied and/or condensables enriched fluid outlet conduits such that the risk of solids, wax and/or hydrate deposition in these secondary outlet conduits is minimized.

### SUMMARY OF THE INVENTION

In accordance with the invention there is provided a multistage fluid separation assembly comprising:
a primary gas cooling devices which has a liquefied and/or solidified condensables enriched fluid outlet; and
a secondary fluid separation vessel having a tubular section of which a central axis has a substantially vertical or tilted orientation, which vessel is connected to said condensables enriched fluid outlet of at least one of said gas cooling devices, wherein during normal operation of the vessel the condensables enriched fluid is induced to swirl around the central axis of the tubular section of the vessel such that a tertiary stream of liquefied and/or solidified condensables is induced by gravity and centrifugal forces to swirl in downward direction alongside the inner surface of the tubular section of the vessel into a liquid collecting tank at or near the bottom of the vessel for collecting a tertiary mixture of liquefied and/or solidified condensables, which tank is provided with one or more heaters for heating the tertiary mixture to reduce the amount of solidified condensables and with one or more outlets for discharging the tertiary mixture from the tank, wherein a plurality of secondary fluid injection conduits of a plurality of primary gas cooling devices are connected at regular circumferential intervals to the tubular section of the secondary separation vessel, which conduits inject in use condensables enriched fluid in an at least partially tangential direction into the interior of the secondary separation vessel.

It is preferred that the tubular section of the secondary separation vessel is equipped with a tertiary gas outlet conduit having an inlet which is located at or near the central axis of the tubular section and which tertiary gas outlet extends through an upper end of the tubular section of the secondary separation vessel.

Suitably, the secondary separation vessel has a dome- or disk-shaped top, which is mounted on top of the tubular section and the tertiary gas outlet conduit is arranged substantially co-axial to the central axis of the tubular section and passes through the center of the top.

Preferably, the liquefied and/or solidified condensables enriched fluid outlet of at least one primary cooling device, such as a cyclonic fluid separator, is connected to a secondary fluid injection conduit which injects the condensables enriched fluid in an at least partially tangential direction into the tubular section of the secondary separation vessel.

It is also preferred that the central axis of the tubular section of the secondary separation vessel has a substantially vertical orientation and that the secondary fluid injection conduits inject in use liquefied and/or solidified condensables enriched fluid in an at least partially tangential and partially downward direction into the interior of the secondary separation vessel.

Suitably, the liquid collecting tank is formed by a cup-shaped tubular lower portion of the second stage separation vessel which is substantially co-axial to the central axis and has a similar or larger internal width than the upper portion of the vessel and a vortex breaker is arranged in the interior of the secondary separation vessel between the lower end of the tubular section and the liquid collecting tank.

The assembly may be provided with one or more ultrasonic vibration transducers for imposing ultrasonic vibrations at a frequency between 20 and 200 KHz on one or more components of the assembly, such as the secondary fluid injection tubes and the vortex breaker, to inhibit deposition of solidified condensables, such as ice, wax and/or hydrates, within the assembly.

The liquid collecting tank may be provided with a grid of heating tubes, which are designed to heat the liquid and solid fluid mixture in the tank to a temperature of at least 15 degrees Celsius.

One or more primary gas cooling devices may comprise cyclonic inertia separators which comprise an expansion nozzle in which the fluid mixture is cooled to a temperature lower than 0 degrees Celsius by a substantially isentropic expansion and in which one or more swirl imparting vanes induce the fluid to swirl into a diverging outlet section which is equipped with a central primary condensables depleted fluid outlet conduit and an outer secondary condensables enriched fluid outlet conduit.

Suitably each primary gas cooling device, such as a cyclonic inertia separator, comprises an expansion nozzle, which is designed to accelerate the fluid mixture within the nozzle to a supersonic speed, thereby cooling in use the temperature of the fluid passing through the nozzle to a temperature lower than −20 degrees Celsius.

The fluid separation assembly according to the invention may comprise a plurality of primary cyclonic inertia separators of which the expansion nozzles are substantially parallel and equidistant to the central axis of the tubular section of the secondary separation vessel and of which the secondary condensables enriched fluid outlets are connected to secondary fluid injection conduits which intersect the wall of the tubular section of the secondary separation vessel at regular circumferential intervals and in an at least partially tangential direction, and which secondary fluid injection conduits each have a length less than 4 meter.

The gas cooling devices may comprise chokes known as Joule-Thompson valves in which the gas is accelerated and cooled by expansion such that a liquefied and/or solidified condensables enriched fluid is generated, which is subsequently fed into the secondary fluid separation vessel.

The invention also relates to a method of separating condensable components from a fluid mixture in a multistage fluid separation assembly, which method comprises:
injecting the fluid mixture into a primary gas cooling devices in which the fluid mixture is expanded and cooled and condensable components are liquefied and/or solidified and optionally separated from the gaseous components by centrifugal force, and in which a stream of condensables enriched fluid components is fed into a secondary fluid outlet; and
injecting the stream of condensables enriched fluid components into a secondary fluid separation vessel having a tubular section of which a central axis has a substantially vertical or tilted orientation and in which the condensables enriched fluid stream is induced to swirl around the central axis of the tubular section of the vessel such that a tertiary mixture of liquefied and/or solidified condensables is induced by gravity and centrifugal forces to swirl in downward direction alongside the inner surface of the tubular section of the vessel into a liquid collecting tank at or near the bottom of the vessel, in which tank the tertiary mixture of liquefied and/or solidified condensables is collected and heated to reduce the amount of solidified condensables and from which tank liquid and/or solidified components are discharged through one or more outlets, wherein a plurality of secondary fluid injection conduits of a plurality of primary gas cooling devices are connected at regular circumferential intervals to the tubular section of the secondary separation vessel, which conduits inject condensables enriched fluid in an at least partially tangential direction into the interior of the secondary separation vessel.

### DESCRIPTION OF SUITABLE EMBODIMENTS

Suitable embodiments of a multistage fluid separation assembly according to the present invention will be described in more detail with reference to the accompanying drawings wherein:

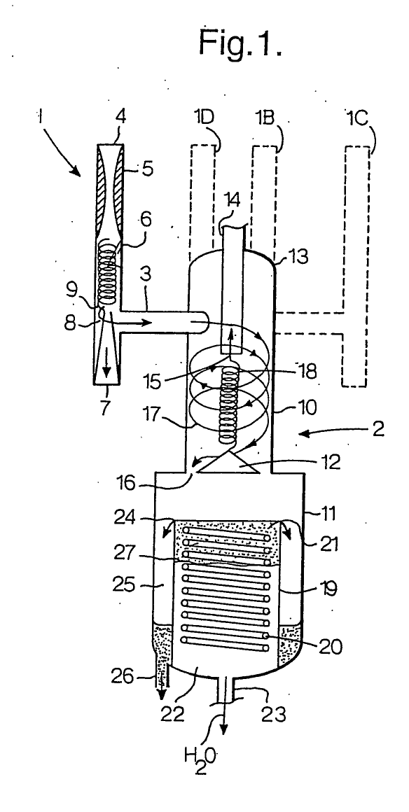

FIG. 1 is a schematic vertical split sectional view of a first suitable embodiment of a multistage fluid separation assembly according to the invention wherein four primary cyclonic inertia separators discharge a condensables enriched fluid mixture into a vertically oriented tubular secondary fluid separation vessel;

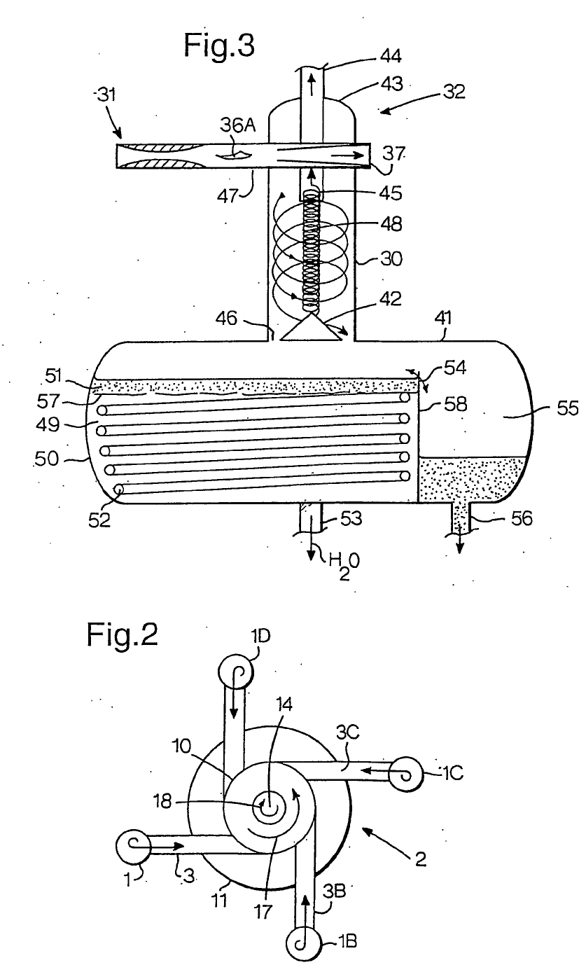

FIG. 2 is a top view of the multistage fluid separation assembly of FIG. 1;

FIG. 3 is a schematic vertical split sectional view of another suitable embodiment of a multistage fluid separation assembly according to the invention wherein two primary cyclonic inertia separators discharge a condensables enriched fluid mixture into a horizontally oriented secondary fluid separation vessel;

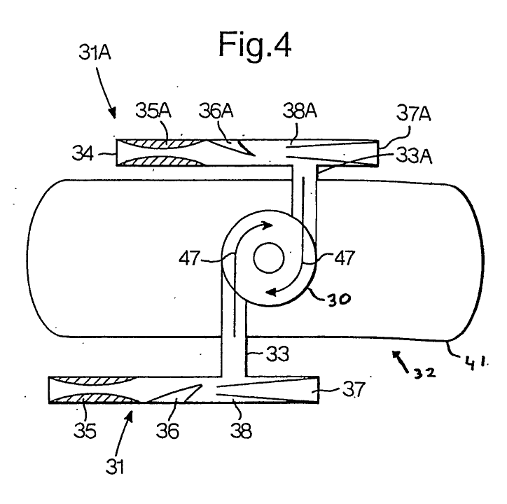

FIG. 4 is a horizontal cross-sectional view of the multistage fluid separation assembly of FIG. 3, taken across the primary cyclonic inertia separators and seen from above;

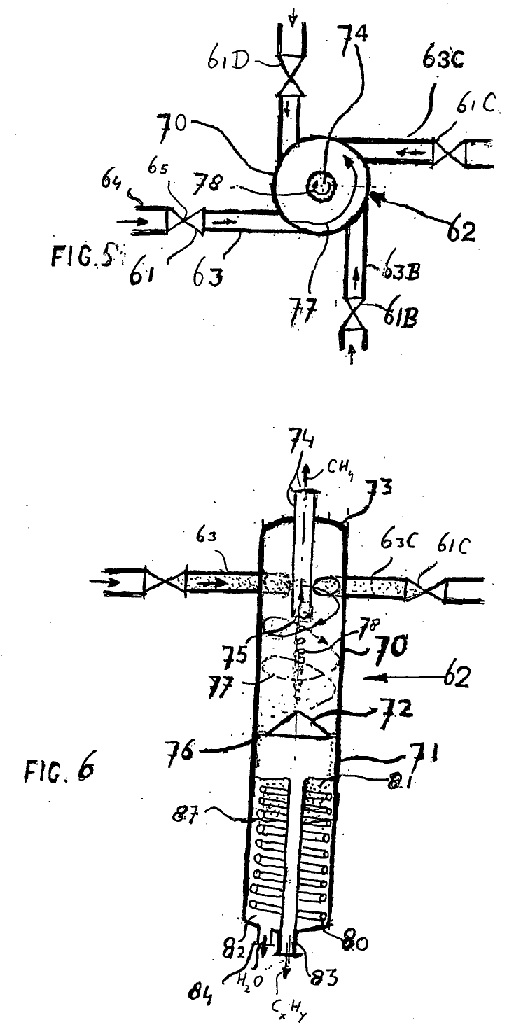

FIG. 5 is a schematic horizontal sectional view of a simplified multistage fluid separation assembly of which the primary gas cooling devices consist of chokes known as Joule Thompson valves; and

FIG. 6 is a schematic vertical sectional view of the assembly shown in FIG. 5.

Referring to FIG. 1 there is shown a primary cyclonic inertia separator 1 which is connected to a secondary LTX fluid separation vessel 2 by a secondary condensables enriched fluid injection conduit 3.

The primary cyclonic inertia separator 1 comprises a fluid inlet 4 which is connected to a wellhead (not shown) of a natural gas production well via which a mixture of natural gas, water vapours, condensates, hydrates and other condensable components are produced.

The fluid mixture flowing into the primary separator 1 is first accelerated to a high, preferably supersonic, velocity in a nozzle 5 and thereby cooled down preferably to a temperature below −20 degrees Celsius, such that water vapour and/or other condensables condense and/or solidify as a result of adiabatic expansion and subsequently induced to swirl by a tilted wing 6 so that the cooled fluid mixture is separated by centrifugal forces into a central flux of condensables depleted natural gas and an annular outer flux of condensables enriched fluid.

The central flux of condensables depleted natural gas is discharged through a central primary condensables depleted outlet 7 into a gas distribution conduit (not shown) and the annular outer flux of condensables enriched fluid is discharged through an annular condensables enriched fluid outlet chamber 8 into the secondary condensables enriched fluid injection conduit 3 as illustrated by arrow 9.

The condensables enriched fluid injection conduit 3 feeds the condensables enriched fluid into a vertical section 10 of the secondary LTX fluid separation vessel 2 for further separation into substantially dry gas, water and liquefied hydrocarbons and hydrates.

As illustrated in FIG. 2 a series of four primary inertia separators 1, 1B, 1C and 1D feed condensable enriched fluid tangentially into the vertical tubular section 10 of the secondary LTX separation vessel 2 via a series of four condensables enriched fluid injection conduits 3, 3B, 3C and 3D.

In FIG. 1 a schematic vertical split sectional view is given of the first primary inertia separator 1 and of the secondary LTX separation vessel 2 and the contours of other three primary inertia separators 1B, 1C and 1D are illustrated in dotted lines.

As illustrated in FIG. 1 the secondary LTX separation vessel 2 comprises below the vertical tubular section 10 a large diameter bottom section 11 in which a tertiary stream of liquids is collected and further separated, a vortex breaker 12 which is located between the tubular and bottom sections 10 and 11 and a dome-shaped top 13 through which a tertiary gas outlet conduit 14 extends into the tubular section 10.

The entrance 15 of the tertiary gas outlet conduit 14 is located below the level at which the condensables enriched fluid inlet conduit 3 debouches into the tubular section 10 of the secondary separation vessel 2.

The fluid injected via the tangential fluid injection conduits 3 into the tubular section 10 will circulate, when seen from above in an anti-clockwise direction, alongside the inner wall of the tubular section 10 as illustrated by arrows 17. A tertiary stream of liquid and/or solid components will be concentrated in the outer periphery of the interior of the tubular section 10 and will as a result of gravitational forces drop through the annular gap 16 alongside the outer circumference of the vortex breaker 12 into a liquid collecting tank 19 within the large diameter bottom section 11 of the secondary fluid separation vessel 2.

Low density gaseous components of the fluid mixture injected via the tangential fluid injection conduits 3, 3B, 3C and 3D into the tubular section 10 will be concentrated near the centre of the tubular section 10 and will flow up into the tertiary gas outlet 14. The arrangement of the entrance 15 of the tertiary gas outlet 14 below the level at which the tangential fluid injection conduits 3, 3B, 3C and 3D inject fluid into the tubular section 10 will generally induce the gaseous components to swirl as an eddy current 18 in an opposite, when seen from above, clockwise direction. The clockwise circulating eddy current 18 of substantially dry gas, which circulates as a result of the Hirsch-Rankin effect in a direction opposite to the outer stream 17 of condensables further enhances the separation of dry gas from the liquid and/or solid components. The vortex breaker 12 has a conical shape and the top of the vortex breaker 12 performs as a vortex seeker for the clockwise rotating central eddy current 18 of dry gas.

The tubular section 10 is a substantially open vessel without swirl imparting vanes, in order to minimise the risk of plugging and/or contamination of the interior of the vessel.

The liquid collecting tank 19 is equipped with heating coils 20 which maintain the collected liquid and solid components at a substantially constant temperature between 15 and 25 degrees Celsius. At this temperature waxes and hydrates will melt and will float up above the water in the liquid collecting tank, such that a top layer 21 of wax, hydrates, condensate and other hydrocarbon liquids will float above a lower layer 22 of water.

Water (H₂O) is discharged through a water discharge conduit 23 at the bottom of the liquid collecting tank 19, whereas the mixture of wax, hydrates, condensate and other hydrocarbons will flow over the upper rim 24 of the liquid collecting tank 19 into an annular hydrocarbon liquids collecting zone 25 which is equipped with a hydrocarbon liquids discharge conduit 26. The water discharge conduit 23 is equipped with a valve (not shown), which is controlled such that the water/hydrocarbon liquids interface 27 is maintained at a substantially constant level.

Optionally the vortex breaker 12 and the walls of the vertical tubular section 10 of the secondary separation vessel 2 and the conduits 3, 3B, 3C and 3D are heated and/or equipped with ultrasonic vibration transducers (not shown) to inhibit deposition of wax, scale and hydrates and other fouling on these components. The ultrasonic vibration transducers preferably vibrate the walls of these fouling sensitive components at a frequency between 20 and 200 KHz to shake off any fouling.

The compact configuration of the multistage separation assembly according to the invention makes it very suitable for use on offshore platforms where deckspace is limited and the presence of small surface areas within the short conduits 3, 3B, 3C and 3D and within the secondary separation vessel, 2 which are vulnerable to fouling and which can be heated and vibrated to remove any fouling allows the use of primary cyclonic separators in which the wet gas is adiabatically cooled to a very low temperature, which may be below minus 20 or even below minus 40 degrees Celsius, such that a maximum amount of water, hydrates, waxes and/or other condensable and/or solidifiable components are condensed and/or solidified without obstructing the associated peripheral conduits 3, 3B, 3C and 3D and secondary LTX separation vessel 2.

Referring now to FIGS. 3 and 4 there is shown another suitable configuration of a multistage fluid separation assembly according to the invention wherein two primary cyclonic inertia separators 31 and 31A discharge a condensables enriched fluid mixture via conduits 33 and 33A tangentially into a vertical tubular top section 30 of a secondary LTX fluid separation vessel 32.

The two primary cyclonic inertia separators 31 and 31A have a horizontal orientation but are otherwise similar to the primary cyclonic inertia separators 1-1D shown in FIGS. 1 and 2 and also comprise a wet gas inlet 34; a nozzle 35, 35A in which the wet natural gas stream is accelerated to a preferably supersonic or near sonic velocity and thereby adiabatically cooled to minus 20 to minus 40 degrees Celsius such that water and other condensable and/or solidifiable components condense and/or solidify and the cooled fluid mixture is swirled around by one or more swirl imparting vanes 36, 36A and separated by centrifugal inertia forces into a central flux of substantially dry gas which is discharged through a central gas outlet 37, 37A and an annular flux of a condensables enriched fluid which is discharged via an annular collecting zone 38, 38A into the conduits 33 and 33A.

The secondary LTX separation vessel 32 comprises below the vertical tubular top section 30 an elongate horizontally oriented tubular bottom section 41 in which liquids are collected and further separated, a vortex breaker 42 which is located between the tubular top and bottom sections 30 and 41 and a dome-shaped cap 43 through which a tertiary gas outlet conduit 44 extends into the tubular top section 38.

The entrance 45 of the tertiary gas outlet conduit 44 is located below the level at which the condensables enriched fluid inlet conduits 33 and 33A debouch into the tubular top section 30 of the secondary separation vessel 32.

The fluid injected via the tangential fluid injection conduits 33 and 33A into the tubular top section 30 will circulate, when seen from above in a clockwise direction, alongside the inner wall of the tubular top section 30 as illustrated by arrows 47. Liquid and/or solid components will be concentrated in the outer periphery of the interior of the tubular section 30 and will as a result of gravitational forces fall down through the annular gap 46 alongside the outer circumference of the vortex breaker 42 into a liquid collecting tank 49 within the elongate tubular bottom section 41 of the secondary fluid separation vessel 32.

Low density gaseous components of the fluid mixture injected via the tangential fluid injection conduits 33 and 33A into the tubular top section 30 will be concentrated near the centre of the tubular top section 30 and will flow up into the tertiary gas outlet 44. The arrangement of the entrance 45 of the tertiary gas outlet 44 below the level at which the tangential fluid injection conduits 44 inject fluid into the tubular top section 30 will generally induce the gaseous components to swirl as an eddy current 48 in an opposite, when seen from above, anti-clockwise direction. The anti-clockwise circulating eddy current 48 of substantially dry gas, which circulates in a direction opposite to the outer stream 47 of condensables further enhances the separation of dry gas from the liquid and/or solid components. The vortex breaker 42 has a conical shape and the top of the vortex breaker 42 performs as a vortex seeker for the anti-clockwise rotating central eddy current 48 of dry gas.

The liquid collecting tank 49 is equipped with heating coils 50 which maintain the collected liquid and solid components at a substantially constant temperature between 15 and 45 degrees Celsius. At this temperature waxes and hydrates will melt and will float up above the water in the liquid collecting tank, such that a top layer 51 of wax, hydrates, condensate and other hydrocarbon liquids will float above a lower layer 52 of water. The foamy top layer 51 will also minimize re-evaporation of the liquid hydrocarbons and will therefore keep the hydrocarbon dewpoint in the upper part of the interior of the LTX vessel 2 low.

Water (H₂O) is discharged through a water discharge conduit 53 at the bottom of the liquid collecting tank 49, whereas the mixture of wax, hydrates, condensate and other hydrocarbons will flow over the upper rim 54 of a bulkhead 58 at the right side of the liquid collecting tank 49 into a hydrocarbon liquids collecting zone 55 which is equipped with a hydrocarbon liquids discharge conduit 56. The water discharge conduit 53 is equipped with a valve (not shown), which is controlled such that the water/hydrocarbon liquids interface 57 is maintained at a substantially constant level.

Optionally the vortex breaker 42 and the walls of the vertical tubular top section 30 of the secondary separation vessel 32 and the conduits 33 and 33 are heated and/or equipped with ultrasonic vibration transducers (not shown) to inhibit deposition of wax, scale and hydrates and other fouling on these components. The ultrasonic vibration transducers preferably vibrate the walls of these fouling sensitive components at a frequency between 20 and 200 KHz to shake off any fouling.

The large volume and horizontal surface area of the liquid collecting tank 49 facilitate low liquid velocities of the separated water and liquefied hydrocarbon components such that an optimal gravity separation of the aqueous and hydrocarbon phases takes place within the tank 49.

It will be understood that the bulkhead 58 may be removed from the tubular bottom section 41 of the vessel 32 and that the hydrocarbon liquid outlet 56 may pass through the sidewall of said tubular bottom section 41 just below the upper surface of the foamy top layer 51 of hydrocarbon liquids.

Referring to FIGS. 5 and 6 there is shown a set of four primary cooling devices 61, 61B, 61C, and 61D which are connected to a secondary LTX fluid separation vessel 62 by a set of four tangential secondary condensables enriched fluid injection conduits 63, 63B, 63C and 63D.

Each primary cooling device comprises a fluid inlet 64 which is connected to a wellhead (not shown) of a natural gas production well via which a mixture of natural gas, water vapours, condensates, hydrates and other condensable components is produced.

The fluid mixture flowing into each primary cooling device 61, 61B, 61C and 61D is accelerated to a high, preferably supersonic, velocity in a flow restriction 65, such as a venturi, choke, or Joule Thompson valve and thereby cooled down preferably to a temperature below −20 degrees Celsius, such that water vapour and/or other condensables condense and/or solidify as a result of adiabatic expansion whereupon a liquefied and/or solidified condensables enriched fluid mixture flows into the narrow secondary fluid injection conduits 63, 63B, 63C and 63D.

Each condensables enriched fluid injection conduit 63, 63B, 63C and 63D feeds the liquefied and/or solidified condensables enriched fluid at high speed into a vertical section 70 of the secondary LTX fluid separation vessel 62 for separation into substantially dry gas, water and liquefied hydrocarbons and hydrates.

As illustrated in FIG. 5 a series of four primary inertia separators 61, 61B, 61C and 61D feed a liquefied and/or solidified enriched fluid mixture tangentially into the vertical tubular section 70 of the secondary LTX separation vessel 62 via a series of four condensables enriched fluid injection conduits 63, 63B, 63C and 63D.

In FIG. 6 a schematic vertical sectional view is given of the primary inertia separator 61 and 61C and of the secondary LTX separation vessel 62.

As illustrated in FIG. 6 the secondary LTX separation vessel 62 comprises below the vertical tubular section 70 a bottom section 71 in which a tertiary stream of liquids is collected and further separated, a vortex breaker 72 which is located between the tubular and bottom sections 70 and 71 and a dome-shaped top 73 through which a tertiary gas outlet conduit 74 extends into the tubular section 70.

The entrance 75 of the tertiary gas outlet conduit 74 is located below the level at which the condensables enriched fluid inlet conduits 63, 63A, 63B and 63C debouch into the tubular section 70 of the secondary separation vessel 62.

The fluid injected via the tangential fluid injection conduits 63 into the tubular section 70 will circulate, when seen from above in an anti-clockwise direction, alongside the inner wall of the tubular section 70 as illustrated by arrows 77. A tertiary stream of liquid and/or solid components will be concentrated in the outer periphery of the interior of the tubular section 70 and will as a result of gravitational forces drop through the annular gap 76 alongside the outer circumference of the vortex breaker 72 into a liquid collecting tank 79 within the bottom section 71 of the secondary fluid separation vessel 62.

Low density gaseous components such as methane (CH₄) etc. of the fluid mixture injected via the tangential fluid injection conduits 63, 63B, 63C and 63D into the tubular section 70 will be concentrated near the centre of the tubular section 70 and will flow up into the tertiary gas outlet 74. The arrangement of the entrance 75 of the tertiary gas outlet 74 below the level at which the tangential fluid injection conduits 63, 63B, 63C and 63D inject fluid into the tubular section 70 will generally induce the gaseous components to swirl as an eddy current 78 in an opposite, when seen from above, clockwise direction. The clockwise circulating eddy current 78 of substantially dry gas, which circulates as a result of the Hirsch-Rankin effect in a direction opposite to the outer stream 77 of condensables further enhances the separation of dry gas from the liquid and/or solid components. The vortex breaker 72 has a conical shape and the top of the vortex breaker 72 performs as a vortex seeker for the clockwise rotating central eddy current 78 of dry gas.

The bottom section 71 of the vessel 62 is equipped with heating coils 80 which maintain the collected liquid and solid components at a substantially constant temperature between 15 and 25 degrees Celsius. At this temperature waxes and hydrates will melt and will float up above the water in the liquid collecting tank, such that a top layer 81 of wax, hydrates, condensate and other hydrocarbon liquids (CₓH_{y}) will float above a lower layer 82 of water.

Water (H₂O) is discharged through a water discharge conduit 64 at the bottom of the vessel 62, whereas the mixture of wax, hydrates, condensate and other hydrocarbons (CₓH_{y}) are discharged via a central hydrocarbon liquids discharge conduit 83. The discharge conduits 83 and 84 may be equipped with valves (not shown), which may be controlled such that the water/hydrocarbon liquids interface 87 is maintained at a substantially constant level.

If desired water and hydrocarbons may be discharged from the vessel 62 via a single liquid outlet at the bottom of the vessel 62 for further separation in a separation unit (not shown) downstream of the vessel 62.

Optionally the vortex breaker 72 and the walls of the vertical tubular section 70 of the secondary separation vessel 62 and the conduits 63, 63B, 63C and 63D are heated and/or equipped with ultrasonic vibration transducers (not shown) to inhibit deposition of wax, scale and hydrates and other fouling on these components. The ultrasonic vibration transducers preferably vibrate the walls of these fouling sensitive components at a frequency between 20 and 200 KHz to shake off any fouling.

The multistage fluid separation assembly according to the invention is also useful for separating solid particles from a gaseous fluid stream. In the gas cooling devices the solid particles will serve as nucleation sources which promote droplet growth of liquefied condensables. The solid particles will flow together with the liquefied condensables into the liquid collecting tank of the secondary fluid separation vessel and are thereby separated from the tertiary stream of condensables depleted, substantially dry gas, that is discharged from the top of the secondary fluid separation vessel.

1. A multistage fluid separation assembly comprising:
a plurality of primary gas cooling device each of which has a liquefied and/or solidified condensables enriched fluid outlet; and,
a secondary fluid separation vessel having a tubular section of which a central axis has a substantially vertical or tilted orientation, which vessel is connected to said condensables enriched fluid outlet of said primary gas cooling devices, wherein during normal operation of the vessel the condensables enriched fluid is induced to swirl around the central axis of the tubular section of the vessel such that a tertiary stream of liquefied and/or solidified condensables is induced by gravity and centrifugal forces to swirl in downward direction alongside the inner surface of the tubular section of the vessel into a liquid collecting tank at or near the bottom of the vessel for collecting a tertiary mixture of liquefied and/or solidified condensables, which tank is provided with one or more heaters for heating the tertiary mixture to reduce the amount of solidified condensables and with one or more outlets for discharging the tertiary mixture from the tank;
wherein the plurality of a liquefied and/or solidified condensables enriched fluid outlets are connected at regular circumferential intervals to the tubular section of the secondary separation vessel, which conduits inject in use condensables enriched fluid in an at least partially tangential direction into the interior of the secondary separation vessel.

2. The fluid separation assembly of claim 1, wherein the liquid collecting tank comprises an upper liquid outlet for low density liquid components and a lower liquid outlet for high density liquid components.

3. The fluid separation assembly of claim 1, wherein the tubular section of the secondary separation vessel is equipped with a tertiary gas outlet conduit having an inlet which is located at or near the central axis of the tubular section.

4. The fluid separation assembly of claim 3, wherein the secondary separation vessel has a dome or disk shaped top which is mounted on top of the tubular section and the tertiary gas outlet conduit is arranged substantially co-axial to the central axis of the tubular section and passes through said top.

5. The fluid separation assembly of claim 1, wherein the liquefied and/or solidified condensables enriched fluid outlet of at least one primary gas cooling device which injects in use the condensables enriched fluid in an at least partially tangential direction into the tubular section of the secondary separation vessel.

6. The fluid separation assembly of claim 5, wherein the central axis of the tubular section of the secondary separation vessel has a substantially vertical orientation and said plurality of primary gas cooling device each of which has a liquefied and/or solidified condensables enriched fluid outlet inject in use condensables enriched fluid in is an at least partially tangential and partially downward direction into the interior of the secondary separation vessel.

7. The fluid separation assembly of claim 1, wherein the liquid collecting tank is formed by a cup-shaped tubular lower portion of the second stage separation vessel which is substantially co-axial to the central axis and has a larger internal width than the upper portion of the vessel.

8. The fluid separation assembly of claim 1, wherein a vortex breaker is arranged in the interior of the secondary separation vessel between the lower end of the tubular section and the liquid collecting tank.

9. The fluid separation assembly of claim 1, wherein the assembly is provided with one or more ultrasonic vibration transducers for imposing ultrasonic vibrations on one or components of the assembly to inhibit deposition of solidified condensables, such as ice, wax and/or hydrates, within the assembly.

10. The fluid separation assembly of claims 5, wherein at least the primary gas cooling device each of which has a liquefied and/or solidified condensables enriched fluid outlet and the vortex breaker are equipped with ultrasonic vibration transducers.

11. The fluid separation assembly of claim 9, wherein the ultrasonic vibration transducers are designed to vibrate in use one or more components of the assembly at a frequency between 20 and 200 KHz.

12. The fluid separation assembly of claim 1, wherein the liquid collecting tank is provided with a grid of heating tubes which are designed to heat the liquid and solid fluid mixture in the tank to a temperature of at least 15 degrees Celsius.

13. The fluid separation assembly of claim 1, wherein at least one gas cooling device comprises a primary cyclonic inertia separator comprising an expansion nozzle in which the fluid mixture is cooled to a temperature lower than 0 degrees Celsius by a substantially isentropic expansion and in which one or more swirl imparting vanes induce the fluid to swirl into a diverging outlet section which is equipped with a central primary condensables depleted fluid outlet conduit and an outer secondary condensables enriched fluid outlet conduit.

14. The fluid separation assembly of claim 13, wherein each primary cyclonic inertia separator comprises an expansion nozzle designed to accelerate the fluid mixture within the nozzle to a supersonic speed, thereby cooling the temperature of the fluid passing through the nozzle to a temperature lower than −20 degrees Celsius.

15. The fluid separation assembly of claim 13, comprising a plurality of primary cyclonic inertia separators of which the expansion nozzles are substantially parallel and equidistant to the central axis of the tubular section of the secondary separation vessel and of which the secondary condensables enriched fluid outlets are connected to secondary fluid injection conduits which intersect the wall of the tubular section of the secondary separation vessel at regular circumferential intervals and in an at least partially tangential direction, and which secondary fluid injection conduits each have a length less than 4 meters.

16. The fluid separation assembly of claim 1, wherein the gas cooling devices comprise chokes.

17. A method of separating condensable components from a fluid mixture in a multistage fluid separation assembly, the method comprising:
injecting the fluid mixture into a primary gas cooling devices in which the fluid mixture is expanded and cooled and condensable components are liquefied and/or solidified, and in which a stream of condensables enriched fluid components is fed into a secondary fluid outlet; and,
injecting the stream of condensables enriched fluid components into a secondary fluid separation vessel having a tubular section of which a central axis has a substantially vertical or tilted orientation and in which the condensables enriched fluid stream is induced to swirl around the central axis of the tubular section of the vessel such that a tertiary mixture of liquefied and/or solidified condensables is induced by gravity and centrifugal forces to swirl in downward direction alongside the inner surface of the tubular section of the vessel into a liquid collecting tank at or near the bottom of the vessel, in which tank the tertiary mixture of liquefied and/or solidified condensables is collected and heated to reduce the amount of solidified condensables and from which tank liquid and/or solidified components are discharged through one or more outlets;
wherein a plurality of secondary fluid injection conduits of a plurality of primary gas cooling devices are connected at regular circumferential intervals to the tubular section of the secondary separation vessel, which conduits inject condensables enriched fluid in an at least partially tangential direction into the interior of the secondary separation vessel.

18. The method of claim 17, wherein the fluid mixture is a natural gas stream which is cooled in gas cooling devices comprising one or more primary cyclonic inertia separators to a temperature below 0 degrees Celsius thereby condensing and/or solidifying aqueous and hydrocarbon condensates and gas hydrates and the tertiary fluid mixture comprises water, ice, hydrocarbon condensates and gas hydrates and is heated in the tertiary fluid collecting tank to a temperature above 15 degrees Celsius to reduce the amount of gas hydrates, and from which tank low density hydrocarbon condensates are discharged through an upper liquid outlet and high density aqueous components are discharged through a lower liquid outlet.

19. The method of claim 17, wherein liquefied and/or solidified components are separated from the gaseous components by centrifugal force in the primary gas cooling device.
